(19) United States
(12) Patent Application Publication
(10) Pub. No.: US 2026/0015505 A1
(43) Pub. Date: Jan. 15, 2026

(54) CELLULOSE NANOCRYSTAL STABILIZED ASPHALT EMULSIONS AND ASSOCIATED METHODS OF USE

(71) Applicants: MICHAEL KAM CHIU TAM, WATERLOO (CA); PARINAZ ATAEIAN, Richmond Hill (CA)

(72) Inventors: MICHAEL KAM CHIU TAM, WATERLOO (CA); PARINAZ ATAEIAN, Richmond Hill (CA)

(21) Appl. No.: 19/263,216

(22) Filed: Jul. 8, 2025

Related U.S. Application Data
(60) Provisional application No. 63/668,915, filed on Jul. 9, 2024.

(51) Int. Cl. C08L 95/00; E01C 7/26; E01C 19/02; E01C 19/22

(52) U.S. Cl. CPC C08L 95/005; E01C 7/26; E01C 19/02; E01C 19/22; C08L 2201/52; C08L 2555/82

(57) ABSTRACT

The present disclosure is related to the asphalt emulsions stabilized by pristine and modified cellulose nanocrystal (CNC) to achieve advantageous stability under various storage and application conditions, as well as reinforced performance properties of the composition. The CNCs can be modified in order to tune the morphological and rheological properties of the emulsion for various applications over a range of paving and industrial applications.

### CROSS-REFENCE TO RELATED APPLICATIONS

This application claims priority to, and the benefit of, U.S. Provisional Application 63/668,915, filed 9 Jul. 2024, which is incorporated by reference herein in its entirety for all purposes.

### BACKGROUND

### 1. Field of the Disclosure

The present disclosure is related to the asphalt emulsions stabilized by pristine and modified cellulose nanocrystal (CNC) to achieve premier stability under various storage and application conditions and reinforced performance properties of the residue.

### 2. Background Information

Asphalt binder (also known as bitumen) is a black sticky viscoelastic material mainly produced from the residue of the petroleum distillation process but can also be found in natural reservoirs such as Trinidad lake. The main application of asphalt binder is in the engineered aggregate skeleton to form asphalt concrete (or asphalt mix).

Other pavement-related applications include asphalt-based tack-coating (adhesive between two consecutive asphalt mix lifts), surface treatments, and aggregate stabilizer. To make asphalt binder workable enough for any application, the viscosity of asphalt must significantly drop. This is typically done by raising the temperature to the range of 220-300° F.—referred to “hot-mix” asphalt. Emulsification of asphalt binder in water using emulsifiers through high shear milling is a known technique to reduce the viscosity to the application range. The low viscosity of asphalt emulsions (0.5-10 Poise at 60° C.) makes it processable at lower temperatures. The reduced working temperature process is called “warm-mix”, and has a wide range of advantages, including but not limited to economic and environmental aspects. (Salomon, 2006).

While surfactant technologies are capable of reducing the working temperatures of asphalt binder, surfactant chemistries suffer from limitations such as emulsion stability, which results in sensitivity to various factors such as storage, application temperature and flow.

Unlike surfactant-based technologies, solid particles are able to provide to oil-in-water systems in Pickering emulsions. In such systems, partitioned particles at the interface provide a solid barrier preventing coalescence of the droplets and stabilize the dispersion.

The rigid rodlike crystals of cellulose nanocrystals (CNC) can be manufactured from cellulose biomass via acid hydrolysis to remove the amorphous region and leave behind the highly crystalline regions. Different acids, like sulfuric, hydrochloride, phosphoric, and nitric acid, have been used on CNC preparations, while sulfuric acid is the most common. (George & Sabapathi, 2015; Lizundia et al., 2020). Typical dimensions of CNCs have been reported to be 3-20 nm in diameter and 100-250 nm in length. CNCs particles are suitable for various chemical modifications due to the abundant hydroxyl groups at their surface area. (Peng et al., 2011; Roy et al., 2009). The orientation of crystalline cellulose planes containing hydrophilic hydroxyl groups and (200) β/(220)α hydrophobic crystalline edge (glucopyranose) exposing hydrophobic —CH groups of CNC provide their amphiphilic nature. (Kalashnikova et al., 2012).

Having intermediate wettability and a rod-like structure with a high aspect ratio and anisotropic behavior provides CNCs with ideal properties as Pickering emulsifiers. (Capron, 2018).

Besides environmental factors, increased traffic load contributes to the gradual stress propagation in pavement structure, which leads to high maintenance and construction costs. For example, conventional surfactant-based asphalt binder emulsions tend to suffer from rutting, cracking, and disintegration especially at extreme temperatures.

The use of nanomaterials in asphalt has potential for improving the pavement's mechanical and physical properties such as durability, viscoelasticity, resistance to ageing, and fatigue damage. However, nano-modified asphalt design and manufacture are limited due to scalability, cost, and agglomeration challenges. (Papadimitropoulos et al., 2018). Thus, there exists a need in the art of asphalt paving to develop more stable and durable asphalt emulsions.

### SUMMARY

The present disclosure provides asphalt emulsions, e.g., Pickering emulsions, comprising cellulose nanocrystals (CNCs), e.g., modified CNCs, paving compositions and surfaces comprising the same, and associated methods of production. Surprisingly, the modified CNC-based asphalt emulsions yielded better processing and performance outcomes, including improvement in at least one of durability, emulsion stability, viscoelasticity, aging-resistance, and resistance to fatigue damage and cracking.

Thus, in an aspect, the disclosure provides a bituminous composition comprising an emulsion including a modified cellulose nanocrystal (CNC) emulsifier and asphalt (in an aqueous phase). In any aspect or embodiment described herein, the emulsion is a Pickering emulsion. In any aspect or embodiment described herein, the emulsion comprises a sufficient amount of modified CNC to result in a Pickering emulsion.

In any aspect or embodiment described herein, the modified CNCs have a hydrodynamic radius ranging from about 50 nm to about 600 nm, or from about 60 nm to about 600 nm, or from about 70 nm to about 600 nm, or from about 80 nm to about 600 nm, or from about 90 nm to about 600 nm, or from about 100 nm to about 600 nm; or from about 50 nm to about 550 nm, or from about 50 nm to about 500 nm; or from about 50 nm to about 500 nm, or from about 60 nm to about 500 nm, or from about 70 nm to about 500 nm, or from about 80 nm to about 500 nm, or from about 90 nm to about 500 nm, or from 100 nm to about 500 nm.

In any aspect or embodiment described herein, the modified CNCs have a diameter/width ranging from about 1 nm to about 50 nm, or from about 5 nm to about 45 nm, or from about 5 nm to about 40 nm, or from about 5 nm to about 35 nm, or from about 5 nm to about 30 nm, or from about 5 nm to about 20nm; or from about 10 nm to about 50 nm, or from about 10 nm to about 45 nm, or from about 10 nm to about 40 nm, or from about 10 nm to about 35 nm, or from about 10 nm to about 30 nm, or from about 10 nm to about 25 nm, or from about 10 nm to about 20 nm.

In any aspect or embodiment described herein, the modified CNCs have a length ranging from about 50 nm to about 600 nm, or from about 60 nm to about 600 nm, or from about 70 nm to about 600 nm, or from about 80 nm to about 600 nm, or from about 90 nm to about 600 nm, or from about 100 nm to about 600 nm; or from about 50 nm to about 550 nm, or from about 50 nm to about 500 nm; or from about 50 nm to about 500 nm, or from about 60 nm to about 500 nm, or from about 70 nm to about 500 nm, or from about 80 nm to about 500 nm, or from about 90 nm to about 500 nm, or from 100 nm to about 500 nm.

In any aspect or embodiment described herein, the modified CNCs have a hydrodynamic radius, width, and length as described above in any combination, e.g., hydrodynamic radius of from about 50 nm to about 600 nm, width of from about 1 nm to about 50 nm, and length of from about 50 nm to about 600 nm. In an additional example, the modified CNCs have a hydrodynamic radius of from about 100 nm to about 500 nm, width of from about 10 nm to about 20 nm, and length of from about 100 nm to about 500 nm.

In any aspect or embodiment described herein, the emulsion comprises from about 0.5 wt % to about 5.0 wt % of a modified CNC emulsifier, or from about 1.0 wt % to about 5.0 wt %, or from about 1.5 wt % to about 5 wt %; or from about 0.5 wt % to about 4.5 wt %, or from about 0.5 wt % to about 4.0 wt %, or from about 0.5 wt % to about 3.5 wt %, or from about 0.5 wt % to about 3.0 wt %, or from about 0.5 wt % to about 2.5 wt %; or from about 1.0 wt % to about 4.5 wt %, or from about 1.5 wt % to about 4.0 wt %, or from about 1.5 wt % to about 3.5 wt %, or from about 1.5 wt % to about 3.0 wt %, or from about 1.5 wt % to about 2.5 wt %.

In any aspect or embodiment described herein, the emulsion further comprises a salt, e.g., NaCl, or CaCl₃, or other charge-shielding agent. In any aspect or embodiment described herein, the emulsion further comprises a salt in an amount of from about 0.05 wt % to about 2.0 wt %, or from about 0.1 wt % to about 2.0 wt %, or from about 0.15 wt % to about 2.0 wt %, or from about 0.2 wt % to about 2.0 wt %, or from about 0.25 wt % to about 2.0 wt %, or from about 0.3 wt % to about 2.0 wt %, or from about 0.35 wt % to about 2.0 wt %, or from about 0.4 wt % to about 2.0 wt %, or from about 0.45 wt % to about 2.0 wt %, or from about 0.5 wt % to about 2.0 wt %.

In any aspect or embodiment described herein, the modified CNC has a net positive, or a net negative charge.

In any aspect or embodiment described herein, the emulsion comprises from about 20 wt % to about 75 wt % of asphalt, or from about 20 wt % to about 70 wt %, or from about 20 wt % to about 65 wt %, or from about 20 wt % to about 60 wt %, or from about 20 wt % to about 55 wt %, or from about 20 wt % to about 50 wt %, or from about 20 wt % to about 45 wt %, or from about 20 wt % to about 40 wt %.

In any aspect or embodiment described herein, the emulsion comprises a ratio of asphalt to water of about 20-75/25-60, e.g., from about 40/60 to 75/25, or 40/60.

In any aspect or embodiment described herein, the emulsion is storage stable for from about 30 days to about two years, or from about 30 days to about a year and a half.

In any aspect or embodiment described herein, the emulsion is temperature stable from about 0° C. to about 80° C.

In certain embodiments, the disclosure provides an asphalt emulsion comprising
from about 1.5 wt % to about 3 wt % CNC;
from about 0.05 wt % to about 1.5 wt % salt; and
a ratio of asphalt to water of 4/6.

In any aspect or embodiment described herein, the bituminous composition further comprises an aggregate. In any aspect or embodiment, the bituminous composition comprises from about 90 wt % to about 95 wt % of an aggregate.

In any aspect or embodiment described herein, the emulsion further comprises at least one additional additive. In any aspect or embodiment described herein, the additive comprises at least one of a surfactant, a rheology modifier, a polymer, recycled tire rubber, polystyrene, butadyene-styrene-butadyene rubber, or a combination thereof.

In any aspect or embodiment described herein, the CNC is pristine CNC or a modified CNC. In any aspect or embodiment described herein, the modified CNC is at least one of TEMPO-oxidized-CNC, desulfated-CNC or a combination thereof.

In any aspect or embodiment described herein, asphalt emulsions comprising a CNC improve at least one of processing and performance outcomes, including improvement in at least one of durability, e.g., high-temperature durability, reduction in processing temperature, emulsion stability, e.g., emulsion storage stability, viscoelasticity, aging-resistance, resistance to fatigue damage and cracking or a combination thereof, as compared to asphalt emulsions in the absence of a CNC.

In an additional aspect, the disclosure provides a method of preparing an asphalt emulsion comprising the steps of:
heating an aqueous-based mixture of CNC emulsifier and salt;
adding molten asphalt into a colloid mill;
breaking asphalt into smaller particle sizes; and
adding the heated aqueous-based mixture and mixing with the asphalt.

In any aspect or embodiment described herein, the method further comprises the step of combining the asphalt emulsion with the aggregates. In any aspect or embodiment described herein, the method further comprises the step of compacting the asphalt emulsion and aggregate to form a paved surface.

In an additional aspect, the disclosure provides a paved surface comprising a bituminous composition comprising aggregate and an asphalt emulsion as described herein, e.g., a Pickering emulsion, comprising cellulose nanocrystals (CNCs), wherein the bituminous composition is compacted to a surface, e.g., a road, driving surface or parking lot.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1. Provides visual images of creaming stability of asphalt emulsion stabilized by surfactant and CNC.

FIG. 2. Illustrates the droplet size of stabilized asphalt droplets which are affected by (a) salt and CNC concentration, (b) various CNC chemical modifications (de storage time of CNC and surfactant based-emulsions.

FIG. 3. Illustrates the optical microscopy images of asphalt emulsions stabilized at different pristine CNC and NaCl concentrations, functionalized-CNC, and commercial surfactants.

FIG. 4. Illustrates the shear strain amplitude sweep test results of asphalt emulsions at 25° C. and 1 Hz (2π Rad/s) loading time and corresponding LVE Limits.

FIG. 5. Provides the calculated LVE values of asphalt emulsions at 25° C. and 1 Hz (2π Rad/s) loading time

FIG. 6. Illustrates the complex viscosity of asphalt emulsions under temperature sweep mode.

FIG. 7. Illustrates the shear-rate dependency of the rotational viscosity of asphalt emulsion at 25° C.

FIG. 8. Illustrates the shear-rate dependency of the rotational viscosity of asphalt emulsion at 75° C.

FIG. 9. Illustrates the Rebuild Time in Three interval thixotropy test (3iTT) to check the thixotropy behavior of asphalt emulsion.

FIG. 10. Illustrates the rheological analysis of the residue in frequency sweep test based on (a) the shear complex modulus master curve, (b) phase angle master curve, (c) black-space diagram, (d) cole-cole diagram (e) storage modulus master curve (f) loss modulus master curve.

FIG. 11. Illustrates the critical rheological temperatures calculated using the 2S2P1D model.

FIG. 12. Illustrates the analysis of asphalt residue based on (a) MSCR creep compliances at 0.1 and 3.2 kPa Shear Stress Levels, (b) linear amplitude sweep test, (c) number of load repetition to failure (c) crack mouth opening at failure.

### DETAILED DESCRIPTION

The present disclosure relates to asphalt emulsions, e.g., Pickering emulsions, comprising modified cellulose nanocrystals (CNCs), paved surfaces comprising the same, and associated methods of production. Surprisingly, the modified CNC-based asphalt emulsions yielded better processing and performance outcomes.

While various embodiments of the present disclosure are described herein, it will be understood by those skilled in the art that such embodiments are provided by way of example only. It will be understood by those skilled in the art that numerous modifications and changes to, and variations and equivalent substitutions of, the embodiments described herein can be made without departing from the scope of the disclosure. It is understood that various alternatives to the embodiments described herein may be employed in practicing the disclosure, and modifications may be made to adapt a particular structure or material to the teachings of the disclosure. It is also understood that every embodiment of the disclosure may optionally be combined with any one or more of the other embodiments described herein which are consistent with that embodiment.

Where elements are presented in list format (e.g., in a Markush group), it is understood that each possible subgroup of the elements is also disclosed, and any one or more elements can be removed from the list or group.

It is also understood that, unless clearly indicated to the contrary, in any method described or claimed herein that includes more than one act or step, the order of the acts or steps of the method is not necessarily limited to the order in which the acts or steps of the method are recited, but the disclosure encompasses embodiments in which the order is so limited.

It is further understood that, in general, where an embodiment in the description or the claims is referred to as comprising one or more features, the disclosure also encompasses embodiments that consist of, or consist essentially of, such feature(s).

It is also understood that any embodiment of the disclosure, e.g., any embodiment found within the prior art, can be explicitly excluded from the claims, regardless of whether or not the specific exclusion is recited in the specification.

Headings are included herein for reference and to aid in locating certain sections. Headings are not intended to limit the scope of the embodiments and concepts described in the sections under those headings, and those embodiments and concepts may have applicability in other sections throughout the entire disclosure.

All patent literature and all non-patent literature cited herein are incorporated herein by reference in their entirety to the same extent as if each patent literature or non-patent literature were specifically and individually indicated to be incorporated herein by reference in its entirety.

Unless otherwise defined, all technical and scientific terms used herein have the same meaning as commonly understood by one of ordinary skill in the art to which this invention belongs.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The term “exemplary” as used herein means “serving as an example, instance or illustration”. Any embodiment or feature characterized herein as “exemplary” is not necessarily to be construed as preferred or advantageous over other embodiments or features.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “cither,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “about” or “approximately” means an acceptable error for a particular value as determined by one of ordinary skill in the art, which depends in part on how the value is measured or determined. In certain embodiments, the term “about” or “approximately” means within one standard deviation. In some embodiments, when no particular margin of error (e.g., a standard deviation to a mean value given in a chart or table of data) is recited, the term “about” or “approximately” means that range which would encompass the recited value and the range which would be included by rounding up or down to the recited value as well, taking into account significant figures. In certain embodiments, the term “about” or “approximately” means within 10% or 5% of the specified value. Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

In any aspect or embodiment, the disclosure provides a bituminous composition comprising an emulsion including a modified cellulose nanocrystal (CNC) emulsifier and asphalt. In any aspect or embodiment, wherein the bituminous composition comprises an aggregate. In any aspect or embodiment, the emulsion comprises an amount of modified CNC sufficient to form a Pickering emulsion, e.g., from about 0.1 wt % to about 4 wt % modified CNC.

In any aspect or embodiment, the emulsion comprises from about 40 wt % to about 75 wt % of asphalt.

In any aspect or embodiment, the bituminous composition comprises from about 90 wt % to about 95 wt % of aggregate. In any aspect or embodiment, the bituminous composition comprises an additional additive. In any aspect or embodiment, the additive comprises at least one of a surfactant, a rheology modifier, a polymer, recycled tire rubber, polystyrene, butadyene-styrene-butadyene rubber, or a combination thereof. In any aspect or embodiment, the modified CNC comprises at least one of TEMPO-oxidized-CNC, desulfated-CNC or a combination thereof.

In any aspect or embodiment, the emulsion improves at least one of processing and performance outcomes, or improvement in at least one of durability, e.g., high-temperature durability, reduction in processing temperature, emulsion stability, e.g., emulsion storage stability, viscoelasticity, aging-resistance, resistance to fatigue damage and cracking or a combination thereof, as compared to asphalt emulsions in the absence of a CNC.

In any aspect or embodiment, the disclosure provides a method of preparing an asphalt emulsion comprising a modified cellulose nanocrystal (CNC) emulsifier as described herein, comprising the steps of:
heating an aqueous-based mixture of a modified CNC emulsifier and salt;
adding malted asphalt into a colloid mill;
breaking asphalt into smaller particle sizes; and
adding the heated aqueous-based mixture and mixing together with the asphalt.

In any aspect or embodiment described herein, the method includes a step of combining the asphalt emulsion with aggregate to form a bituminous composition.

In any aspect or embodiment described herein, the method further comprises the step of compacting the bituminous composition to form a paved surface.

In any aspect or embodiment described herein, the disclosure provides a paved surface comprising a bituminous composition as described herein.

### EXAMPLES

As the negative surface charge of modified cellulose nanocrystals (CNC) extracted by sulfuric acid leads to electrostatic repulsion, the charge density of CNC was adjusted by introducing electrolytes or surface modification methods. The effect of salt addition on different values was evaluated by applying different NaCl content. In addition, modification of CNC to decrease the surface charge was done to improve the partitioning behavior of CNC particles at the interface of asphalt droplets. The first modification was based on removing the sulfur ester groups on the surface of CNC. (Zoppe et al., 2014) Also, CNC has been modified with TEMPO (2,2,6,6-Tetramethyl-1-piperidinyloxy) reagents. TEMPO-oxidized CNC can be prepared by substituting C6-hydroxyl groups with C6-carboxyl groups on the CNC surface. (Fraschini et al., 2017).

The properties of stabilized asphalt emulsions were analyzed by following characterization methods:
Particle size distribution and morphology to evaluate droplet size and morphology of asphalt emulsions; and
Rheological properties of emulsions were determined by analyzing linear viscoelastic region, temperature sweep, shear rate dependency, and thixotropy.

A further aspect of the disclosure relates to analyzing the durability and mechanical effect of modified CNC on asphalt residue. The preparation procedure and characterization of CNC-modified-asphalt residue are presented in the following:
asphalt residue containing modified CNC or surfactant is extracted from prepared asphalt emulsions through heating the thin layer of each emulsion in the oven at 60° C.
the properties of asphalt extracted as evaluated based on complex shear modulus (G*) under frequency sweep mode over a wide temperature range, linear amplitude sweep test (LAS), and multiple stress creep recovery test (MSCR).

The particle size, particle size distribution, and morphology of asphalt emulsions were evaluated via the laser diffraction technology of the Particle size analyzer and optical microscopy. Rheology characterization of prepared asphalt emulsions was designed based on the amplitude, temperature, and frequency sweep tests.

### Example 1—Preparation of Modified CNC

### Desulf-CNC Preparation

Sulfate ester groups on the surface of modified CNC particles were removed by sodium hydroxide (NaOH). (Beck & Bouchard, 2014; Zhang, 2014; Zoppe et al., 2014). The lower negative charge of Desuf-CNC as an interfacial stabilizer has higher amphiphilicity properties, improving their partitioning behavior at the interface of asphalt and water. However, agglomeration of Desulf-CNC in water dispersion due to their low electrostatic repulsion may limit their diffusion and adsorption kinetics.

### TEMPO-CNC Preparation

Oxidized-CNC were prepared through grafting carboxylic functional groups on the surface of CNC (Fraschini et al., 2017; Jia et al., 2016). Due to the effect of pH values on the charge of carboxylic groups, we believe that 2,2,6,6-tetramethyl-1-piperidinyloxy (TEMPO)-oxidized-CNC provide can provide “smart” pH-responsive asphalt emulsion. The setting time of asphalt emulsion can be designed based on the pH values. (Mikulcová et al., 2018).

### Preparation of Asphalt Emulsion

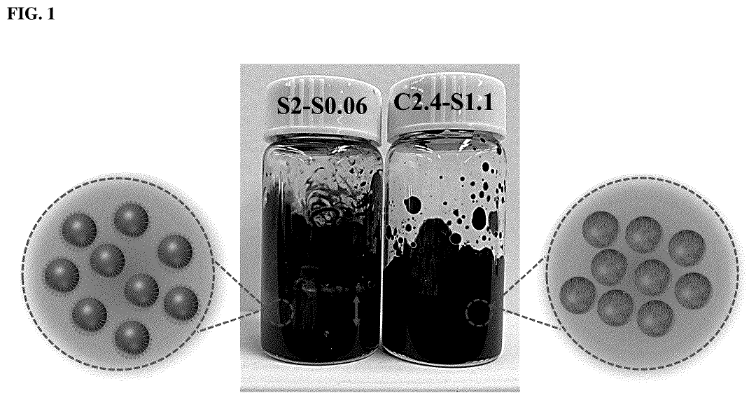

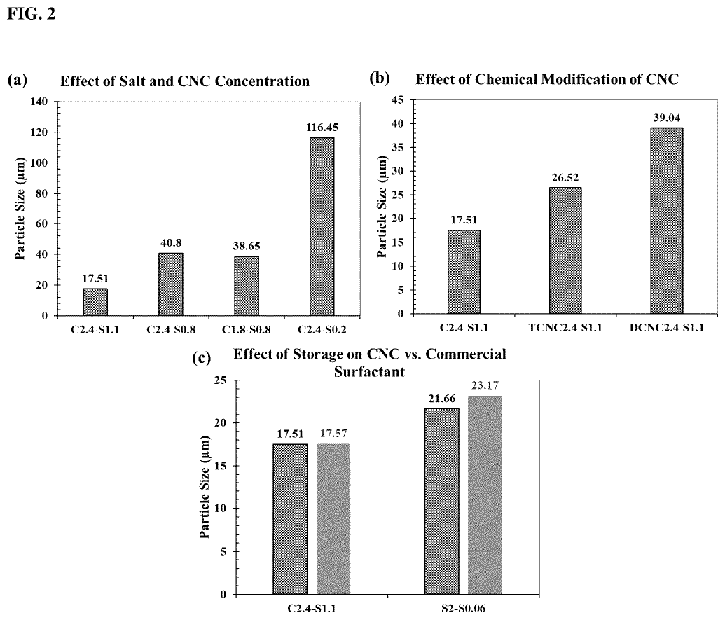

Asphalt binder emulsified at 40/60 ratio of oil/water phases using various concentrations of modified CNC and NaCl. In addition, TEMPO-CNC and Desulf-CNC as functionalized CNC were used to prepare asphalt emulsion. One surfactant-based asphalt emulsion was prepared as a control sample. Each emulsion was prepared by adding a warmed aqueous phase containing CNC and Salt (about 70° C.) to heated asphalt on the colloid mill. The list of samples” names and their composition are listed in Table 1. FIG. 1 presents the C2.4-S1.1 and S2-S0.06.

TABLE 1
Sample Formulations.

| | Emulsifier | Emulsifier | Salt | |
|---|---|---|---|---|
| Name | Type | (wt. %)* | (wt. %)* | Asphalt/Water |
| C2.4-S1.1 | CNC | 2.4 | 1.1 | 4/6 |
| C2.4-S0.8 | CNC | 2.4 | 0.8 | 4/6 |
| C1.8-S0.8 | CNC | 1.8 | 0.8 | 4/6 |
| C2.4-S0.2 | CNC | 2.4 | 0.2 | 4/6 |
| TCNC2.4-S1.1 | TEMPO-CNC | 2.4 | 1.1 | 4/6 |
| DCNC2.4-S1.1 | Desulf-CNC | 2.4 | 1.1 | 4/6 |
| S2-S0.06 | Surfactant | 2 | 0.06 | 4/6 |

### Example 2—Asphalt Emulsion Characterization

### Particle Size Distribution

An Anton Paar PSA 1190 particle size analyzer measured the droplet distribution of prepared asphalt emulsions. The droplet size measurement was conducted by adding 5-30% of asphalt emulsions, and each result was reported as an average of three-time measurements. It was shown that salt remarkably affects electrostatic repulsion between CNC particles and increases salt concentration from 0.8 to 1.1wt. % leads to the droplet size reduction (FIG. 2(a)). Surface-modified CNC particles did not alter the droplet size significantly (FIG. 2(b)). The stability of asphalt emulsions stabilized by CNC and surfactant compared based on their droplet size after two weeks storage at room temperature (FIG. 2(c)). The results proved that the irreversible adsorption of CNC enhances the emulsion's stability. The results of the droplet size of emulsions are presented in Table 2.

TABLE 2
The average droplet size of asphalt in different samples.

Mean Diameter (μm)

| Sample | Fresh samples | Two-week storage |
|---|---|---|
| C2.4-S1.1 | 17.5 | 17.6 |
| C2.4-S0.8 | 40.8 | — |
| C1.8-S0.8 | 38.6 | — |
| C2.4-S0.2 | 116.4 | — |
| TCNC2.4-S1.1 | 26.5 | — |
| DCNC2.4-S1.1 | 31.8 | — |
| S2-S0.06 | 21.6 | 23.2 |

### Optical Microscopy Images

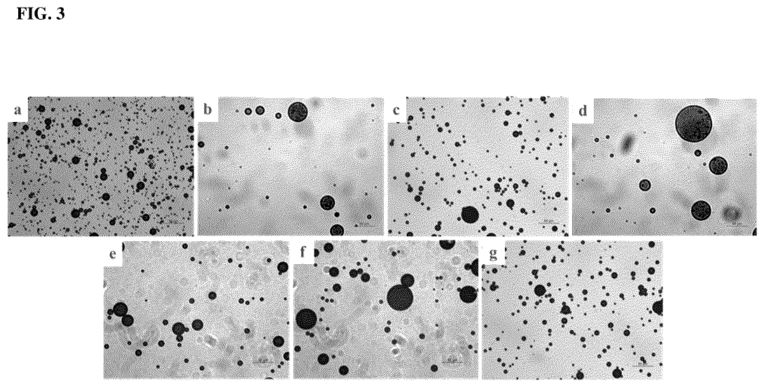

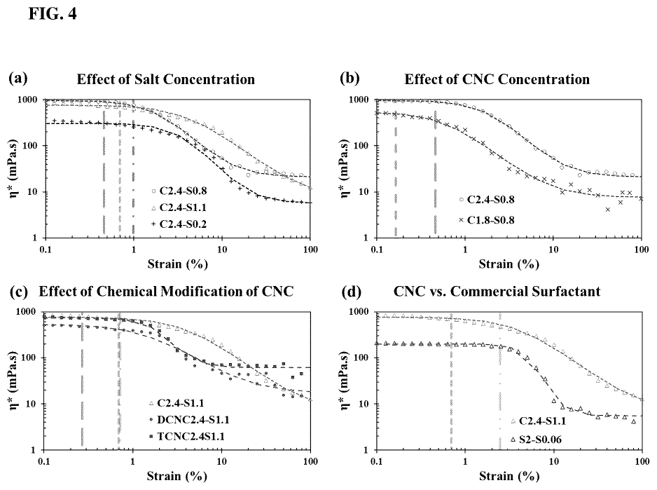

The morphology of the asphalt emulsions was observed through the optical microscope using a Nikon Elipse Ti-S (Agilent Cary Eclipse) equipped with a CCD camera (QImaging ReTIGA 2000R). One droplet of ten-time diluted prepared asphalt emulsion was added on a glass slide, and the images were recorded using bright-field microscopy. The optical microscopic images of asphalt emulsions confirmed the droplet size results (FIG. 3). The W/O/W CNC-based asphalt emulsion was observed on the C2.4-S0.2 sample relating to the low salt concentration. Agglomeration of desulfated-CNC with low surface charge results in less available dispersed particles to stabilize the asphalt emulsion (DCNC2.4-S1.1), leading to a larger droplet size compared to C2.4-S1.1 and TCNC2.4-S1.1

### Linear Viscoelastic Region (LVE)

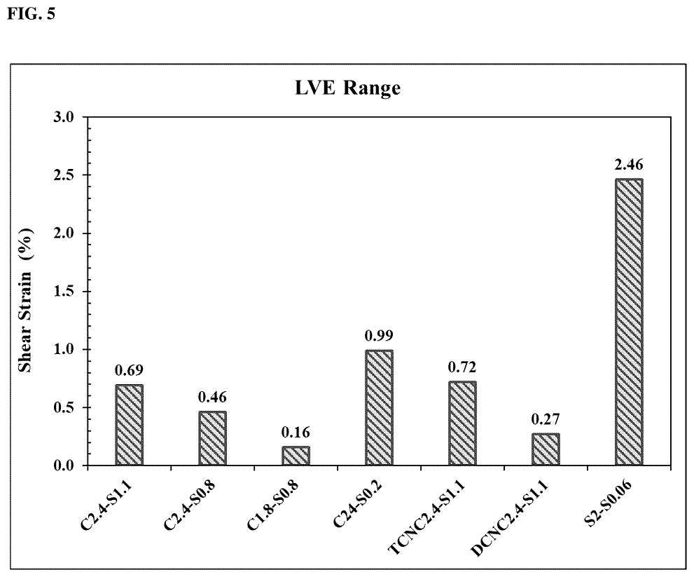

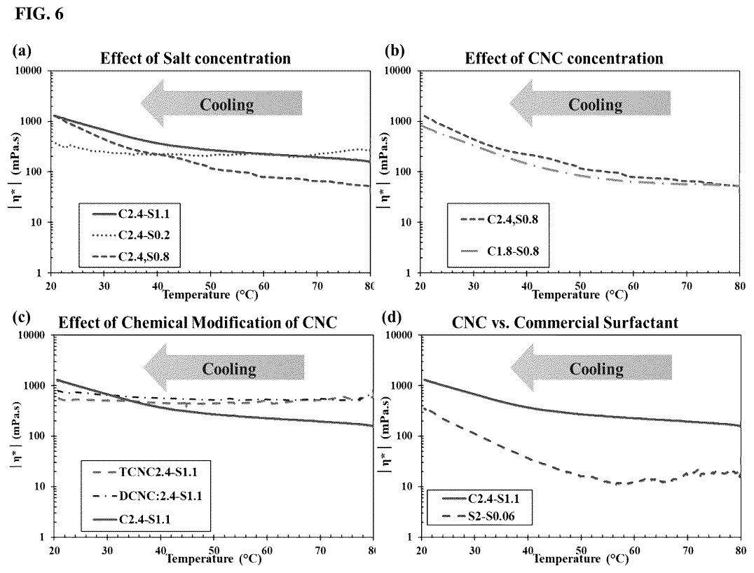

The amplitude sweep (0.1-100%) at 25° C. and 1 Hz (2π Rad/s) loading frequency was performed to evaluate the linear viscosity region of emulsions. The laboratory results were fitted via Eq. (1) to measure the LVE region based on a 5% drop in complex viscosity value (Eq. (2)) (presented in FIG. 4 and FIG. 5).

$$\vert {η}^{*} \vert = {η}_{∞} + ( \frac{{η}_{0} - {η}_{∞}}{1 + a \cdot {γ}^{P}} ) \qquad ( 1 )$$

$$η ( {γ}_{LVE} ) = 0.95 \cdot {η}_{0} \qquad ( 2 )$$

where η* is the magnitude of complex viscosity, η0 and η∞ are maximum and minimum values for the curve with the same dimension as viscosity, γ is shear strain amplitude, and a and P are the shape parameters.

The shear strain amplitude test and the calculated LVE values are presented in FIG. 4 and FIG. 5. Emulsions containing higher CNC concentrations present larger LVE values relating to the interconnect network between free CNC particles in the continuous phase. It was displayed, the high salt content reduces the LVE limit due to the charge-induced effect of excess free salt on the conditioning phase. Also, low CNC concentration could not cover the droplet interface resulting lower LVE range and lower stability. The LVE region of a surfactant-based emulsion depends on the repulsion between particles, while interaction between particles on Pickering emulsions mainly defines the LVE limit.

### Temperature Sweep

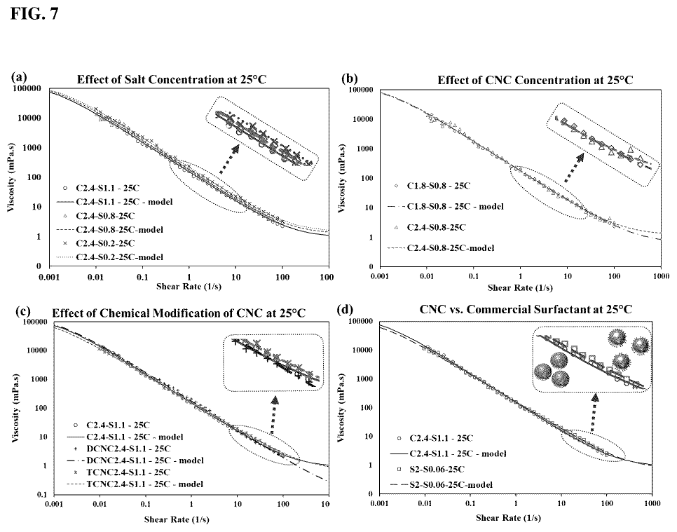

The stability properties of asphalt emulsions at different temperatures were analyzed through temperature sweep from 80 to 20° C. at two ° C./min. As shown in FIG. 6, varying salt and CNC content did not affect on viscosity properties of emulsions at different temperatures. While, modified-CNC presents more stable viscosity profiles than pristine CNC, which relates to higher droplet coverage and more excellent emulsion stability. Irreversible absorbance of CNC particles at the interface of asphalt droplets provides a slight rise in emulsion viscosity after temperature reduction and droplet solidification. However, the aggregation droplet of asphalt emulsions stabilized by surfactant increased the viscosity sharply.

### Shear Rate Dependency

The viscosity profile of asphalt emulsions under shear rate (10-2 to 10³ s⁻¹) was compared according to the shear rate test at 25 and 75° C. The shear rate-dependent viscosity of various asphalt emulsions was modelled using Eq. (3).

$$η ( \dot{γ} ) = {η}_{∞} + ( \frac{{η}_{0} - {η}_{∞}}{1 + {α ( \dot{γ} )}^{β}} ) \qquad ( 3 )$$

where η is the rotational viscosity, \dot{γ} is the shear rate, η₀ and η_{∞} are extreme values of viscosity corresponding to zero-shear and infinity, and α and β are shape parameters.

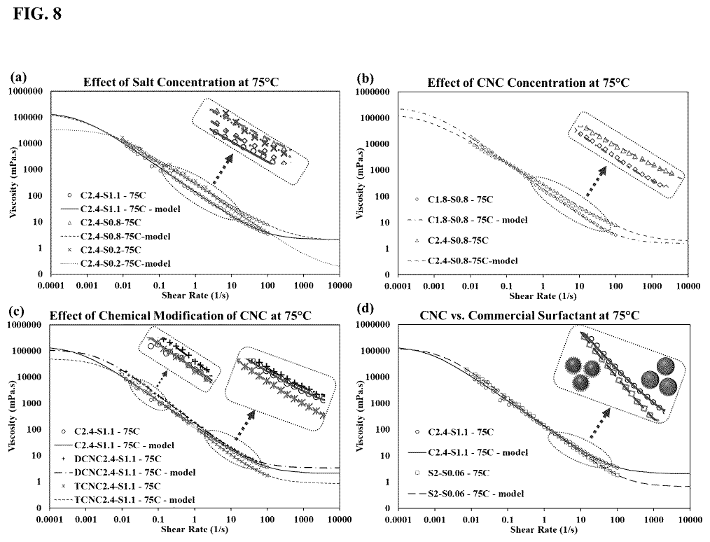

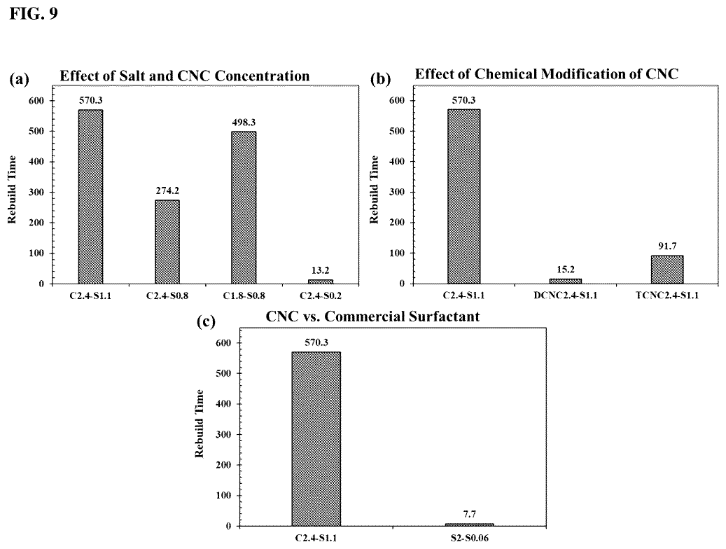

Two temperatures of 25 and 75° C. were selected to analyze the behavior of emulsion under applying shear force relating to the physical properties effect of oil phase on the liquid and solid form of asphalt (FIG. 7 and FIG. 8). In general, all sheared emulsions at 25° C. present similar viscosity profiles. In comparison, the viscosity of emulsions at 75° C. exhibited viscosity profile that was more distinct from 25° C.

Three Interval Thixotropy Test (3iTT)

The thixotropy behavior of CNC-based asphalt emulsions was compared with asphalt emulsion stabilized via surfactant using intervals thixotropy test (3iTT) in a controlled shear rate (CSR) mode. The recoverable viscosity values of emulsions were evaluated to analyze the emulsion properties after spraying on the road. As presented in FIG. 9, the salt and CNC concentration is significantly on the rebuild time relating to the interaction between CNC particles at the interface on droplets. It was observed that the surfactant-based asphalt emulsions did not have thixotropy properties, which is challenging on emulsion design for some specific applications such as chip seal.

### Example 3—Asphalt Residue Characterization

A further aspect of the present disclosure relates to nanosized CNC particles with a rod-like shape which improves the shelf-life, mechanical and rheological properties of asphalt residues. The properties of asphalt emulsions were evaluated by heating the thin layers of prepared asphalt emulsions and water evaporation. This procedure provides asphalt residue that is similar to the settled separated asphalt cement from emulsions on the pavement structure. The residue asphalt cement from prepared emulsions was evaluated through rheological analysis.

### The 2.2.2 Linear Viscoelastic Range Analysis

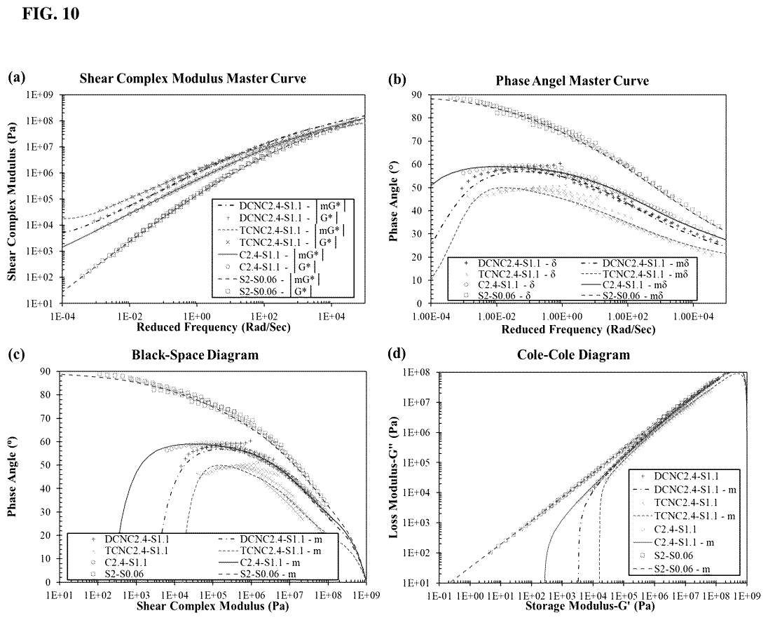

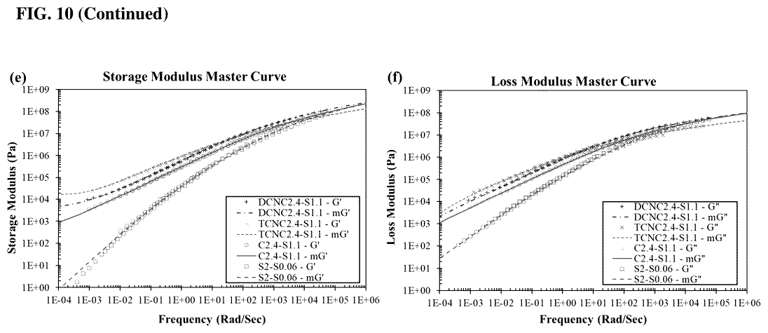

The effect of surfactant and CNC on the properties of asphalt residue was evaluated through the complex shear modulus (G*) under frequency sweep mode (0.1-100 rad/sec) over a wide temperature range (0 to 75° C.) (presented in FIG. 10). The constant strain level was applied in the range of the linear viscoelastic region. According to the modified Arrhenius model (Eq. (4)), the time-temperature superposition principle in conjugation with the 2S2P1D was used to evaluate the viscoelastic properties of asphalt residues. (Alamdary & Azimi Alamdary, 2019; Alamdary & Baaj, 2021; Olard et al., 2003) The complex modulus (G*) and phase angle (δ) master curve were measured using Eq. (5).

$$log {a}_{T} = {10}^{{C}^{1}} ( \frac{1}{{T}^{{C}_{2}}} - \frac{1}{{T}_{r}^{{C}_{2}}} ) \qquad ( 4 )$$

where a_{T} is shift factor, T and Tᵣ are test temperature, and reference temperature in Kelvins and C1 and C2 are model constants.

$${G}^{*} ( i ωτ ) = {G}_{0} + \frac{{G}_{∞} - {G}_{0}}{1 + {δ ( i ωτ )}^{- k} + {( i ωτ )}^{- h} + {( i ωβτ )}^{- 1}} \qquad ( 5 )$$

where G*(iωτ) is the shear complex modulus at the reference temperature as a function of loading frequency, G₀ is the minimum complex number under static load, G_{∞} is the maximum value of complex modulus, ω is the loading frequency in rad/s, k, h, and β are model parameters, and δ and τ are shape parameters.

During reduction of frequency values, the surfactant-based residue was softened, while the network between dispersed CNC in asphalt residue leads to stiffer behavior (FIG. 10(a)). TCNC having carboxyl groups results in higher network connection, resulting in a plateau at low-frequency ranges. The phase angle master curve presents the increasing phase angle values of SDS-containing asphalt due to softening behaviour at low frequencies. In comparison, the phase angle of CNC-based samples after reaching a maximum value reduced phase angle values relating to their returnable clastic behavior (FIG. 10(b)).

As presented in the black-space diagram (FIG. 10(c)), increasing the phase angle (δ) from 0 to 90° presents the elastic asphalt with surfactant convert to viscous liquid with maximum complex modulus values. While restored elastic properties of CNC-based samples limit the increase of complex modulus. TEMPO-CNC's stiffness effect on asphalt leads to barely meeting the δ=450° related to equal loss and storage modulus values. Cole-Cole diagram (FIG. 10(d) presents the linear relation between loss and storage modulus of surfactant-based asphalt, while the network connection between CNC particles in asphalt residues results in a minimum storage modulus value. Evaluation of loss and storage modulus over frequency range confirmed the higher loss and storage values of CNC-containing samples than surfactant-based ones. Also, CNC prevents reduction of storage modulus due to stiffer profile of CNC-based samples.

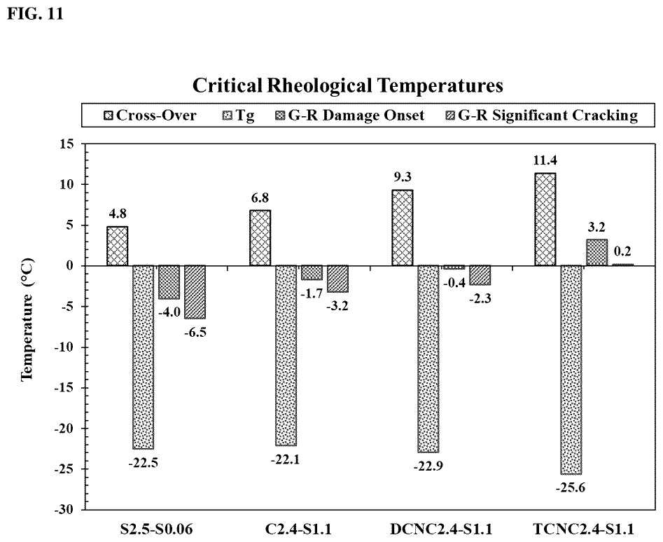

According to the 2S2P1D model, different critical performance-related temperatures include Crossover temperature, Critical Glover-Rowe temperatures, glass transition temperature (FIG. 11).

The Crossover temperature is used to characterize the fatigue cracking resistance of asphalt under repeated loading forces. It is defined as a temperature where the loss modulus equals the storage modulus. The Crossover temperatures were calculated based on the fatigue crack initiation under 10 rad/s loading. So, the higher values of the crossover temperature for CNC-based samples present their higher elastic properties at the intermediate temperature. Residue from TCNC2.4-S1.1 sample form higher interconnected network between particles which reinforced asphalt residue and increased the Crossover temperature.

The Glover-Rowe temperatures of asphalt samples were calculated relating to the temperature which damage onset and crack significantly. According to the Glover-Rowe parameter measurement) Eq. (6), the crack resistance of asphalt was characterized based on the damage onset and initiation of significant asphalt cracking at 180 and 450 kPa.

$$G - R = {G}^{*} \times ( \frac{cos {δ}^{2}}{sin δ} ) @ 0.005 Rad / s \qquad ( 6 )$$

The network between CNC particles leads to stiffer behavior of asphalt result in higher Glover-Rowe temperatures. However, the crossover and Glover-Rowe temperatures are defined based on simple materials.

The CNC-based asphalt residues as the composite structure were evaluated through the rheological glass transition temperature relating to the low-temperature crack. All CNC-containing samples except TEMPO-CNC present low glass transition temperature, which indicated the CNC network connection did not increase the fatigue cracking at low temperature.

The modification in the viscoelastic and performance properties of the asphalt binder was within linear and non-linear viscoelastic ranges. Significant improvement in elastic bahaviour within the LVE range was proved by comparing complex modulus and phase angle master curves of modified and nonmodified asphalt binder residues. Multiple stress creep recovery tests (MSCR) improved permanent deformation resistance for CNC-containing samples at high shear strains.

### Analysis on the Non-Linear Viscoelastic Regime

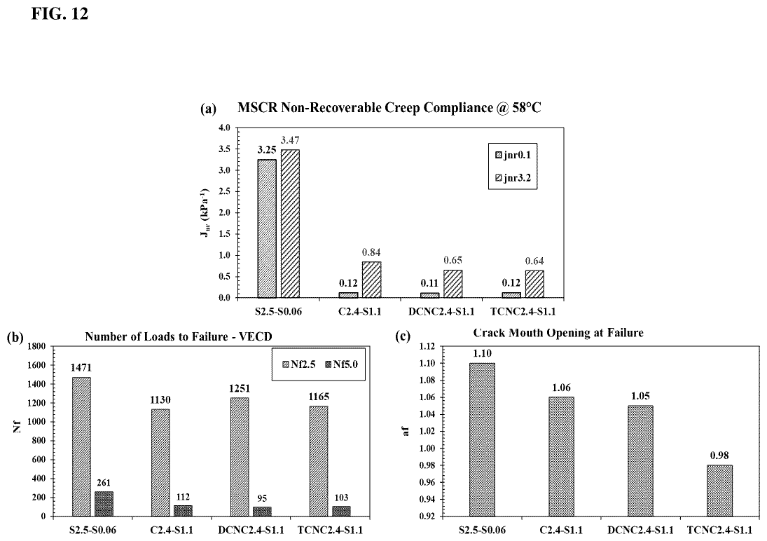

Asphalt's deformation resistance at high performance temperature was evaluated using the multiple stress creep recovery (MSCR) tests relating to rutting resistance properties. The Non-recoverable creep compliance (Jₙᵣ) was measured at two different stress levels of 0.1 and 3.2 kPa under 0.1 s loading followed by 0.9 s rest period. According to the used asphalt, the MSCR test at 58° C. (according to the used asphalt) indicated that The Jₙᵣ values of CNC-based samples are significantly lower than asphalt containing surfactant to higher permanent deformation-resistant. J_{nr 0.1} for the CNC-containing samples was lower than their J_{nr3.2} (FIG. 12(a)).

The asphalt's fatigue and fracture resistance were analyzed using the Linear Amplitude Sweep (LAS) test. The number of load repetitions to failure at strain levels of 2.5 and 5.0 percent and the Fracture Index (FI) was calculated based on the Viscoelastic Continuum Damage (VECD) theory and the fracture index analysis (FIA), respectively. Asphalt having CNC particles present lower fatigue life; however, crack opening CNC-based samples occurred later due to the bridging effect of the CNC network (FIGS. 12(b) and (c)).

### REFERENCES

The following references are incorporated herein by reference in their entirety for all purposes:
ADDIN Mendeley Bibliography CSL_BIBLIOGRAPHY Alamdary, Y. A., & Azimi Alamdary, Y. (2019). Investigation of Different Factors Affecting Asphalt Cement Ageing and Durability [Waterloo]. http://hdl.handle.net/10012/14911
Alamdary, Y. A., & Baaj, H. (2021). Time-temperature superposition of asphalt materials and temperature sensitivity of rheological parameters (Tsrp). Canadian Journal of Civil Engineering, 48(10), 1354-1363. https://doi.org/10.1139/cjce-2020-0490
Beck, S., & Bouchard, J. (2014). Auto-catalyzed acidic desulfation of cellulose nanocrystals. Nordic Pulp and Paper Research Journal, 29(1), 6-14. https://doi.org/10.3183/npprj-2014-29-01-p006-014
Capron, I. (2018). Application of Nanocellulose as Pickering Emulsifier. Nanocellulose and Sustainability, 175-196. https://doi.org/10.1201/9781351262927-9
Fraschini, C., Chauve, G., & Bouchard, J. (2017). TEMPO-mediated surface oxidation of cellulose nanocrystals (CNCs). Cellulose, 24(7), 2775-2790. https://doi.org/10.1007/s10570-017-1319-5
George, J., & Sabapathi, S. N. (2015). Cellulose nanocrystals: synthesis, functional properties, and applications. Nanotechnology, Science and Applications, 8, 45-54. https://doi.org/10.2147/NSA.S64386
Jia, Y., Zhai, X., Fu, W., Liu, Y., Li, F., & Zhong, C. (2016). Surfactant-free emulsions stabilized by tempo-oxidized bacterial cellulose. Carbohydrate Polymers, 151, 907-915. https://doi.org/10.1016/j.carbpol.2016.05.099
Kalashnikova, I., Bizot, H., Cathala, B., & Capron, I. (2012). Modulation of cellulose nanocrystals amphiphilic properties to stabilize oil/water interface. Biomacromolecules, 13(1), 267-275. https://doi.org/10.1021/bm201599j
Lizundia, E., Puglia, D., Nguyen, T. D., & Armentano, I. (2020). Cellulose nanocrystal based multifunctional nanohybrids. Progress in Materials Science, 112(March), 100668. https://doi.org/10.1016/j.pmatsci.2020.100668
Mikulcová, V., Bordes, R., Minařík, A., & Kašpárková, V. (2018). Pickering oil-in-water emulsions stabilized by carboxylated cellulose nanocrystals—Effect of the pH. Food Hydrocolloids, 80, 60-67. https://doi.org/10.1016/j.foodhyd.2018.01.034
Olard, F., Benedetto, H. Di, & Di Benedetto, H. (2003). General “2S2P1D” Model and Relation Between the Linear Viscoelastic Behaviours of Bituminous Binders and Mixes. Road Materials and Pavement Design, 4(2), 185-224. https://doi.org/10.1080/14680629.2003.9689946
Papadimitropoulos, V. C., Karatzas, S. K., & Chassiakos, A. P. (2018). Applications of Nanomaterials in Pavement Engineering: A Review. The Tenth International Conference on Construction in the 21st Century (CITC-10), July 9. http://files/533/Papadimitropoulos et al.—Applications of Nanomaterials in Pavement Engineer.pdf
Peng, B. L., Dhar, N., Liu, H. L., & Tam, K. C. (2011). Chemistry and applications of nanocrystalline cellulose and its derivatives: A nanotechnology perspective. The Canadian Journal of Chemical Engineering, 89(5), 1191-1206. https://doi.org/10.1002/cjce.20554
Roy, D., Semsarilar, M., Guthrie, J. T., & Perrier, S. (2009). Cellulose modification by polymer grafting: a review. Chemical Society Reviews, 38(7), 2046. https://doi.org/10.1039/b808639g
Salomon, D. R. (2006). Asphalt Emulsion Technology. Asphalt Emulsion Technology, August, 58. https://doi.org/10.17226/23246
Zhang, F. (2014). Synthesis of β-Cyclodextrin Functionalized Cellulose Nanocrystals and Their Interactions with Amphiphilic Compounds [Waterloo]. http://hdl.handle.net/10012/8656
Zoppe, J. O., Ruottinen, V., Ruotsalainen, J., Rönkkö, S., Johansson, L. S., Hinkkanen, A., Järvinen, K., & Seppälä, J. (2014). Synthesis of cellulose nanocrystals carrying tyrosine sulfate mimetic ligands and inhibition of alphavirus infection. Biomacromolecules, 15(4), 1534-1542. https://doi.org/10.1021/bm500229d

What is claimed is:

1. A bituminous composition comprising an emulsion including a modified cellulose nanocrystal (CNC) emulsifier and asphalt.

2. The bituminous composition of claim 1, comprising an aggregate.

3. The bituminous composition of claim 1, wherein the emulsion comprises an amount of CNC sufficient to form a Pickering emulsion.

4. The bituminous composition of claim 3, wherein the emulsion comprises from about 0.1 wt % to about 4 wt % modified CNC.

5. The bituminous composition of 1, wherein at least one of (i) the emulsion comprises from about 40 wt % to about 75 wt % of asphalt, (ii) the composition comprises from about 90 wt % to about 95 wt % of aggregate, or (iii) a combination thereof.

6. The bituminous composition of claim 2, wherein at least one of (i) the emulsion comprises from about 40 wt % to about 75 wt % of asphalt, (ii) the composition comprises from about 90 wt % to about 95 wt % of aggregate, or (iii) a combination thereof.

7. The bituminous composition of claim 3, wherein at least one of (i) the emulsion comprises from about 40 wt % to about 75 wt % of asphalt, (ii) the composition comprises from about 90 wt % to about 95 wt % of aggregate, or (iii) a combination thereof.

8. The bituminous composition of claim 4, wherein at least one of (i) the emulsion comprises from about 40 wt % to about 75 wt % of asphalt, (ii) the composition comprises from about 90 wt % to about 95 wt % of aggregate, or (iii) a combination thereof.

9. The bituminous composition of claim 1, comprising an additional additive.

10. The bituminous composition of claim 2, comprising an additional additive.

11. The bituminous composition or claim 3, wherein the additive comprises at least one of a surfactant, a rheology modifier, a polymer, recycled tire rubber, polystyrene, butadyene-styrene-butadyene rubber, or a combination thereof.

12. The bituminous composition or claim 4, wherein the additive comprises at least one of a surfactant, a rheology modifier, a polymer, recycled tire rubber, polystyrene, butadyene-styrene-butadyene rubber, or a combination thereof.

13. The bituminous composition of clam 1, wherein the modified CNC comprises at least one of TEMPO-oxidized-CNC, desulfated-CNC or a combination thereof.

14. The bituminous composition of clam 2, wherein the modified CNC comprises at least one of TEMPO-oxidized-CNC, desulfated-CNC or a combination thereof.

15. The bituminous composition of claim 1, wherein the emulsion improves at least one of processing and performance outcomes, or improvement in at least one of durability, e.g., high-temperature durability, reduction in processing temperature, emulsion stability, e.g., emulsion storage stability, viscoelasticity, aging-resistance, resistance to fatigue damage and cracking or a combination thereof, as compared to asphalt emulsions in the absence of a CNC.

16. The bituminous composition of claim 2, wherein the emulsion improves at least one of processing and performance outcomes, or improvement in at least one of durability, e.g., high-temperature durability, reduction in processing temperature, emulsion stability, e.g., emulsion storage stability, viscoelasticity, aging-resistance, resistance to fatigue damage and cracking or a combination thereof, as compared to asphalt emulsions in the absence of a CNC.

17. A method of preparing an asphalt emulsion comprising a modified cellulose nanocrystal (CNC) emulsifier as described herein, comprising the steps of:
heating an aqueous-based mixture of a modified CNC emulsifier and salt;
adding malted asphalt into a colloid mill;
breaking asphalt into smaller particle sizes; and
adding the heated aqueous-based mixture and mixing together with the asphalt.

18. The method of claim 15, further comprising the step of combining the asphalt emulsion with aggregate to form a bituminous composition.

19. The method of claim 15, further comprising the step of compacting the bituminous composition to form a paved surface.

20. A paved surface comprising a bituminous composition as described herein.
